(19) United States
(12) Patent Application Publication
(10) Pub. No.: US 2016/0232049 A1
(43) Pub. Date: Aug. 11, 2016

(54) INFORMATION PROCESSING APPARATUS, INFORMATION PROCESSING METHOD, AND COMPUTER-READABLE RECORDING MEDIUM

(71) Applicant: Kenji KAWASUMI, Kanagawa (JP)

(72) Inventor: Kenji KAWASUMI, Kanagawa (JP)

(21) Appl. No.: 15/014,139

(22) Filed: Feb. 3, 2016

(30) Foreign Application Priority Data
Feb. 9, 2015 (JP) 2015-023445

(51) Int. Cl. G06F 11/07

(52) U.S. Cl. CPC G06F 11/079; G06F 11/0721

(57) ABSTRACT

An information processing apparatus includes a processor that performs program stored in memory. The processor performs steps of: obtaining, for each of at least one region, status information concerning a non-normal status having occurred in at least one device arranged in the region, from among a plurality of devices to be managed; calculating operation information of the at least one device based on the obtained status information for each of the at least one region; and outputting recommendation information indicating a recommendation based on the operation information of the at least one device.

### CROSS-REFERENCE TO RELATED APPLICATION

The present application claims priority to and incorporates by reference the entire contents of Japanese Patent Application No. 2015-023445 filed in Japan on Feb. 9, 2015.

### BACKGROUND OF THE INVENTION

1. Field of the Invention

The present invention relates to an information processing apparatus, an information processing method, and a computer-readable recording medium.

2. Description of the Related Art

Conventionally, known has been a technique of managing operational statuses such as operation availability, the number of failures, and failure contents of a device in a customer environment and providing a customer with the operational statuses of the device as a service report in a field of an MPS (Managed Print Service). Detailed information of the technique can be obtained in Japanese Laid-open Patent Publication No. 2011-100283, for example.

However, the service report is used only for the purpose of checking whether or not a contract signed with a customer is honored in the conventional technique as explained above and device-related information which is accumulated daily in managing the operational statuses of the device has not been utilized for MPS service like a utilization for improving the operational statuses of the device.

### SUMMARY OF THE INVENTION

It is an object of the present invention to at least partially solve the problems in the conventional technology.

According to an embodiment, there is provided an information processing apparatus that includes a processor that performs program stored in memory. The processor performs steps of: obtaining, for each of at least one region, status information concerning a non-normal status having occurred in at least one device arranged in the region, from among a plurality of devices to be managed; calculating operation information of the at least one device based on the obtained status information for each of the at least one region; and outputting recommendation information indicating a recommendation based on the operation information of the at least one device.

According to another embodiment, there is provided an information processing method performed by a processor that performs program stored in memory. The method includes steps of: storing status information concerning a non-normal status having occurred in a plurality of devices as management target; obtaining, for each of at least one region, status information of at least one device arranged in the region, from among a plurality of devices to be managed; calculating operation information of the at least one device based on the obtained status information for each of the at least one region; and outputting recommendation information indicating a recommendation based on the operation information of the at least one device.

According to still another embodiment, there is provided a non-transitory computer-readable storage medium with an executable program stored thereon and executed by a computer. The program instructs the computer to perform: obtaining, for each of at least one region, status information concerning a non-normal status having occurred in at least one device arranged in the region, from among a plurality of devices to be managed; calculating operation information of the at least one device based on the obtained status information for each of the at least one region; and outputting recommendation information indicating a recommendation based on the operation information of the at least one device.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an example of a configuration of an information processing system 1 according to a first embodiment;

FIG. 2 is a block diagram of an example of a hardware configuration of a customer management unit 10 according to the first embodiment;

FIG. 3 is a block diagram of an example of a functional configuration of the customer management unit 10 according to the first embodiment;

FIG. 4 illustrates an example of customer information according to the first embodiment;

FIG. 5 is a block diagram of an example of a hardware configuration of a group management unit 20 according to the first embodiment;

FIG. 6 is a block diagram of an example of a functional configuration of the group management unit 20 according to the first embodiment;

FIG. 7 illustrates an example of group information according to the first embodiment;

FIG. 8 is a block diagram of an example of a hardware configuration of a device management unit 30 according to the first embodiment;

FIG. 9 is a block diagram of an example of a functional configuration of the device management unit 30 according to the first embodiment;

FIG. 10 illustrates an example of device information according to the first embodiment;

FIG. 11 is a block diagram of an example of a hardware configuration of a status management unit 50 according to the first embodiment;

FIG. 12 is a block diagram of an example of a functional configuration of the status management unit 50 according to the first embodiment;

FIG. 13 illustrates an example of status information according to the first embodiment;

FIG. 14 is a block diagram of an example of a hardware configuration of an information processing apparatus 60 according to the first embodiment;

FIG. 15 is a block diagram of an example of a functional configuration of the information processing apparatus 60 according to the first embodiment;

FIG. 16 illustrates an example of a hierarchy structure of the customer information, the group information, the device information, and the status information according to the first embodiment;

FIG. 17 illustrates an example of operation information for each group according to the first embodiment;

FIG. 18 illustrates another example of operation information for each group according to the first embodiment;

FIG. 19 illustrates still another example of operation information for each group according to the first embodiment;

FIG. 20 illustrates an example of person recovery information according to the first embodiment;

FIG. 21 illustrates another example of person recovery information according to the first embodiment;

FIG. 22 illustrates still another example of person recovery information according to the first embodiment;

FIG. 23 illustrates an example of recommendation information according to the first embodiment;

FIG. 24 illustrates another example of recommendation information according to the first embodiment;

FIG. 25 illustrates still another example of recommendation information according to the first embodiment;

FIG. 26 is a flowchart of an example of a processing to be executed by the information processing apparatus according to the first embodiment;

FIG. 27 is a block diagram of an example of a configuration of an information processing apparatus according to a second embodiment;

FIG. 28 illustrates an example of a hierarchy structure of customer information, group information, device information, and status information according to the second embodiment;

FIG. 29 illustrates an example of operation information according to the second embodiment;

FIG. 30 illustrates another example of operation information according to the second embodiment; and

FIG. 31 is a flowchart of an example of a processing to be executed by the information processing apparatus according to the second embodiment.

### DETAILED DESCRIPTION OF THE PREFERRED EMBODIMENTS

Exemplary embodiments of an information processing apparatus, an information processing system, a recommendation method, and a computer program product will be explained in detail below with reference to the accompanying drawings.

### First Embodiment

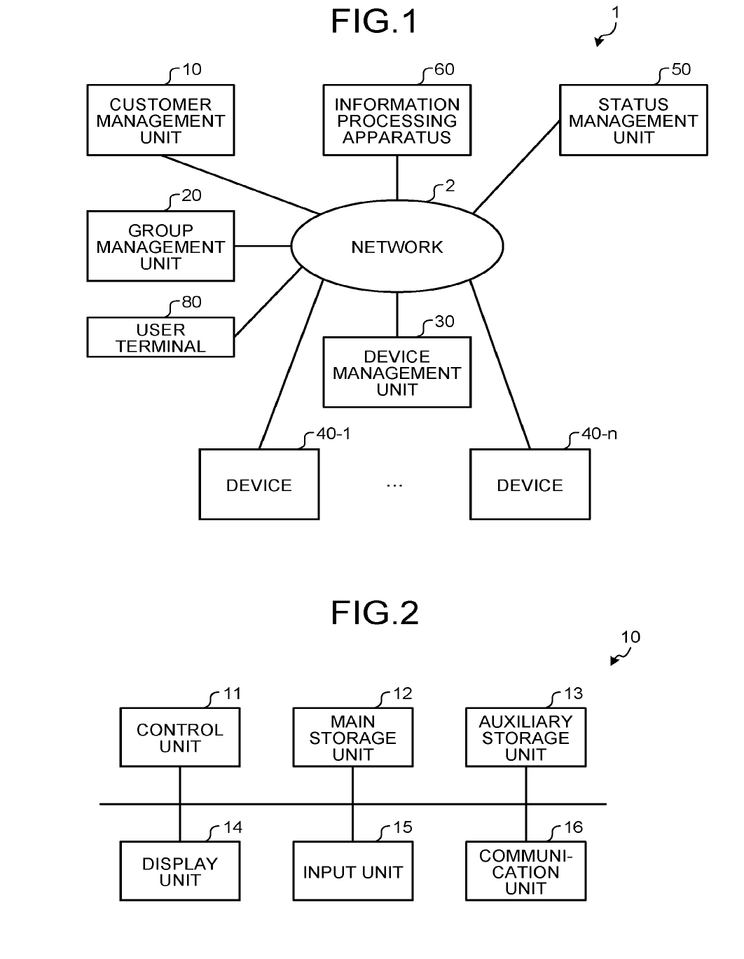

FIG. 1 is a block diagram of an example of a configuration of an information processing system 1 according to a first embodiment. As illustrated in FIG. 1, the information processing system 1 is provided with a customer management unit 10, a group management unit 20, a device management unit 30, devices 40-1 to 40-n (n≧1), a status management unit 50, an information processing apparatus 60, and a user terminal 80. The customer management unit 10, the group management unit 20, the device management unit 30, the devices 40-1 to 40-n, the status management unit 50, the information processing apparatus 60, and the user terminal 80 are connected via a network 2. The network 2 is, for example, realized by the Internet, a LAN (Local Area Network), and the like.

FIG. 2 is a block diagram of an example of a hardware configuration of the customer management unit 10 according to the first embodiment. As illustrated in FIG. 2, the customer management unit 10, which is provided with a control unit 11 such as a CPU (Central Processing Unit) and a GPU (Graphics Processing Unit), a main storage unit 12 such as a ROM (Read Only Memory) and a RAM (Random Access Memory), an auxiliary storage unit 13 such as an HDD (Hard Disk Drive) and an SSD (Solid State Drive), a display unit 14 such as a display, an input unit 15 such as a mouse, a keyset, and a touch-sensitive panel, and a communication unit 16 such as a communication interface, has a hardware configuration using a normal computer. The auxiliary storage unit 13, the display unit 14, the input unit 15, and the communication unit 16 may be provided each as a built-in unit or an external unit.

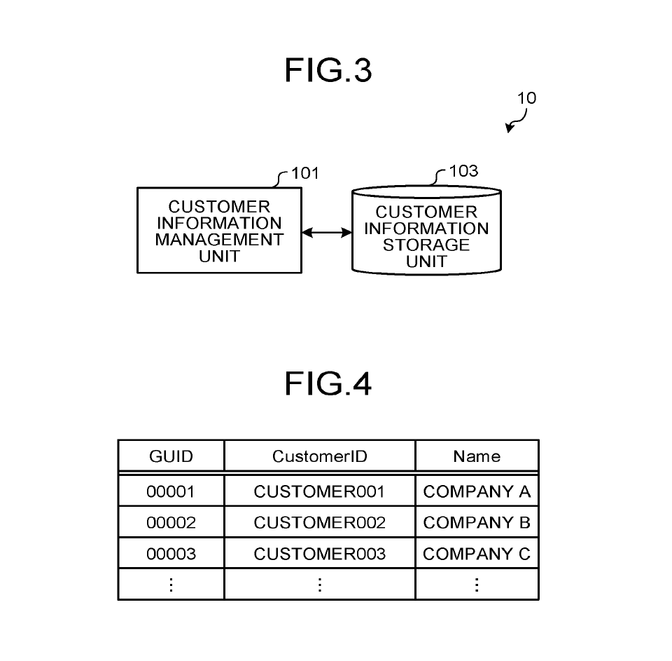

FIG. 3 is a block diagram of an example of a functional configuration of the customer management unit 10 according to the first embodiment. The customer management unit 10, which manages customer information, is provided with a customer information management unit 101 and a customer information storage unit 103 as illustrated in FIG. 3. The customer information management unit 101 can be realized by the control unit 11 and the main storage unit 12 and the customer information storage unit 103 can be realized by the auxiliary storage unit 13, for example.

The customer information storage unit 103 stores customer information which is information concerning customers. FIG. 4 illustrates an example of customer information according to the first embodiment. In the example illustrated in FIG. 4, customer information includes information in which GUID (Globally Unique Identifier), CustomerID, and Name are associated. The “GUID” is an identifier that identifies a record of customer information (column of customer information). The “CustomerID” (an example of customer identifying information) is an identifier that identifies a customer. The “Name” is a name of a customer.

The customer information management unit 101 manages an input and an output of the customer information stored in the customer information storage unit 103. The customer information management unit 101 updates the customer information stored in the customer information storage unit 103 when new customer information is input or update information of existing customer information is input via the input unit 15 by a management person and the like of the customer management unit 10, for example.

When a Name is input via the communication unit 16 from the information processing apparatus 60, for example, the customer information management unit 101 obtains a record of customer information including the Name from the customer information stored in the customer information storage unit 103 and responds to the information processing apparatus 60 with the record. It is necessary that the record of the customer information obtained by the customer information management unit 101 at least includes the “CustomerID” associated with the “Name”.

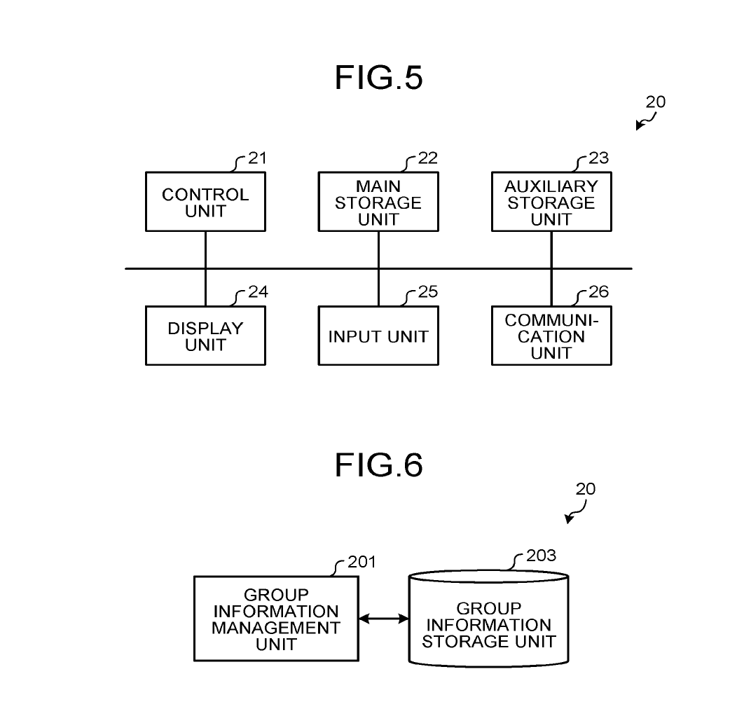

FIG. 5 is a block diagram of an example of a hardware configuration of the group management unit 20 according to the first embodiment. As illustrated in FIG. 5, the group management unit 20, which is provided with a control unit 21 such as a CPU and a GPU, a main storage unit 22 such as a ROM and a RAM, an auxiliary storage unit 23 such as an HDD and an SSD, a display unit 24 such as a display, an input unit 25 such as a mouse, a keyset, and a touch-sensitive panel, and a communication unit 26 such as a communication interface, has a hardware configuration using a normal computer. The auxiliary storage unit 23, the display unit 24, the input unit 25, and the communication unit 26 may be provided each as a built-in unit or an external unit.

FIG. 6 is a block diagram of an example of a functional configuration of the group management unit 20 according to the first embodiment. The group management unit 20, which manages group information, is provided with a group information management unit 201 and a group information storage unit 203 as illustrated in FIG. 6. The group information management unit 201 can be realized by the control unit 21 and the main storage unit 22 and the group information storage unit 203 can be realized by the auxiliary storage unit 23, for example.

The group information storage unit 203 stores group information (an example of region information) which is information concerning groups of a customer. It is at least necessary that groups of a customer divide the customer into segments, and a region structure of the customer such as a continent, a country, a community, and a city can be listed. While a case where the region structure is adopted for groups is taken as an example in the first embodiment, the present invention is not limited thereto and an organization structure of the customer may be adopted, for example. Besides, a hierarchy structure may be adopted for groups.

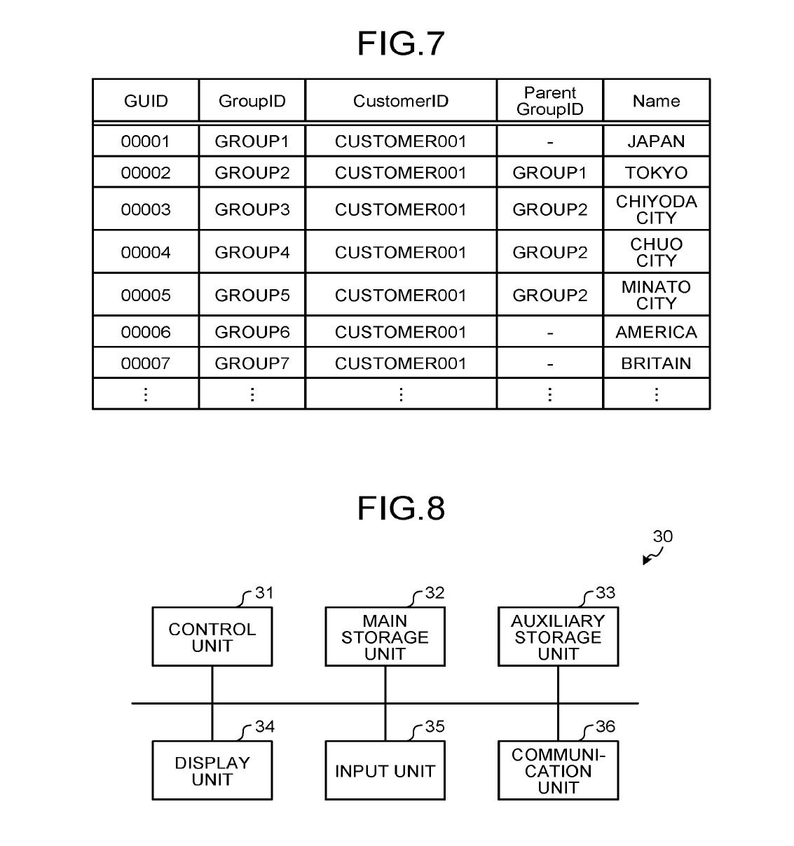

FIG. 7 illustrates an example of group information according to the first embodiment. In the example illustrated in FIG. 7, group information includes information in which GUID, GroupID, CustomerID, Parent GroupID, and Name are associated. The “GUID” is an identifier that identifies a record of group information (column of group information). The “GroupID” (an example of region identifying information) is an identifier that identifies a group. The “CustomerID” is an identifier that identifies a customer. The “Parent GroupID” is an identifier that identifies a superior group. The “Name” is the name of a group.

In the examples illustrated in FIGS. 4 and 7, groups (region structure) of a company A whose CustomerID is “CUSTOMER001” includes Japan whose GroupID is “GROUP1”, America whose GroupID is “GROUP6”, Britain whose GroupID is “GROUP7”, and the like. Here, the hierarchy structure is such that Chiyoda city whose GroupID is “GROUP3”, Chuo city whose GroupID is “GROUP4”, and Minato city whose GroupID is “GROUP5” belong to Tokyo whose GroupID is “GROUP2” and which belongs to Japan whose GroupID is “GROUP1”.

The group information management unit 201 manages an input and an output of the group information stored in the group information storage unit 203. The group information management unit 201 updates the group information stored in the group information storage unit 203 when new group information is input or update information of existing group information is input via the input unit 25 by a management person and the like of the group management unit 20, for example.

When a CustomerID is input via the communication unit 26 from the information processing apparatus 60 for example, the group information management unit 201 obtains a record of group information including the CustomerID from the group information stored in the group information storage unit 203 and responds to the information processing apparatus 60 with the record. It is necessary that the record of the group information obtained by the group information management unit 201 at least includes the “GroupID” associated with the “CustomerID”.

FIG. 8 is a block diagram of an example of a hardware configuration of the device management unit 30 according to the first embodiment. As illustrated in FIG. 8, the device management unit 30, which is provided with a control unit 31 such as a CPU and a GPU, a main storage unit 32 such as a ROM and a RAM, an auxiliary storage unit 33 such as an HDD and an SSD, a display unit 34 such as a display, an input unit 35 such as a mouse, a keyset, and a touch-sensitive panel, and a communication unit 36 such as a communication interface, has a hardware configuration using a normal computer. The auxiliary storage unit 33, the display unit 34, the input unit 35, and the communication unit 36 may be provided each as a built-in unit or an external unit.

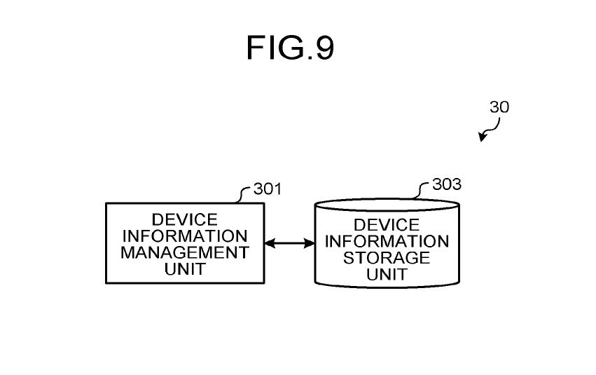

FIG. 9 is a block diagram of an example of a functional configuration of the device management unit 30 according to the first embodiment. The device management unit 30, which manages device information of the devices 40-1 to 40-n (examples of a plurality of devices each as a management target), is provided with a device information management unit 301 and a device information storage unit 303 as illustrated in FIG. 9. The device information management unit 301 can be realized by the control unit 31 and the main storage unit 32 and the device information storage unit 303 can be realized by the auxiliary storage unit 33, for example.

For the devices 40-1 to 40-n, image forming devices such as a printer, a copying machine, an MFP (Multifunction Peripheral), a scanner device, and a facsimile device; various kinds of electronic devices such as a projector, a camera, an air conditioner, a refrigerator, a fluorescent light, a vending machine, and a hand-held terminal; a PC, and a tablet device can be listed. A multifunction peripheral includes at least two of a copying function, a printing function, a scanner function, and a facsimile function. While the devices 40-1 to 40-n are assumed to be image forming devices in the first embodiment, the present invention is not limited thereto.

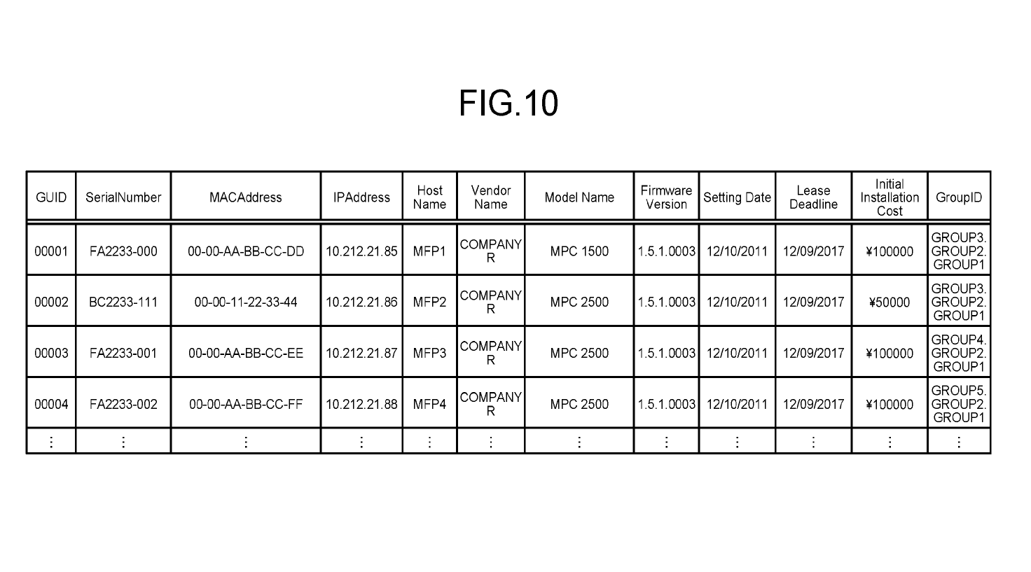

The device information storage unit 303 stores device information of the devices 40-1 to 40-n. The device information may be any information as long as the information is about device management. FIG. 10 illustrates an example of device information according to the first embodiment. In the example illustrated in FIG. 10, the device information includes information in which GUID, SerialNumber, MACAddress, IPAddress, Host Name, Vendor Name, Model Name, Firmware Version, Setting Date, Lease Deadline, Initial Installation Cost, and GroupID are associated.

The “GUID” is an identifier that identifies a record of device information (column of device information). The “SerialNumber” (an example of model identifying information) is an identifier that identifies a device. A device with the SerialNumber is owned by a group with the GroupID (more specifically, by a customer with the CustomerID associated with the GroupID in the group information illustrated in FIG. 7). The “MACAddress” is an MAC address of a device. The “IPAddress” is an IP address of a device. The “Host Name” is a host name of a device. The “Vendor Name” is a vendor name of a device. The “Model Name” (an example of model identifying information) is a model name that indicates a model as a classification of a device. The “Firmware Version” is a version of a firmware installed in a device. The “Setting Date” is a date when a device is set (installed) in a customer environment. The “Lease Deadline” is a deadline of a lease of a device to the customer. The “Initial Installation Cost is an initial cost necessary for an installation of a device to the customer environment. The “GroupID” is an identifier that identifies a group.

The device information management unit 301 manages an input and an output of the device information stored in the device information storage unit 303. The device information management unit 301 obtains device information via the communication unit 36 from the devices 40-1 to 40-n for example, stores the device information in the device information storage unit 303 when the device information is new, and updates the device information stored in the device information storage unit 303 when the device information is existing device information. Specifically, the device information management unit 301 performs a communication using a general-purpose protocol such as the SNMP (Simple Network Management Protocol) generally used for device management with the devices 40-1 to 40-n to obtain device information. For a method of obtaining device information, a method in which the device information management unit 301 voluntarily obtains device information from the devices 40-1 to 40-n or a method in which the devices 40-1 to 40-n voluntarily notify the device management unit 30 (the device information management unit 301) of device information may be adopted.

When a GroupID is input from the information processing apparatus 60 via the communication unit 36 for example, the device information management unit 301 obtains a record of device information including the GroupID from the device information stored in the device information storage unit 303 and responds to the information processing apparatus 60 with the record. Here, it is necessary that the record of the device information obtained by the device information management unit 301 at least includes the “SerialNumber” associated with the “GroupID”.

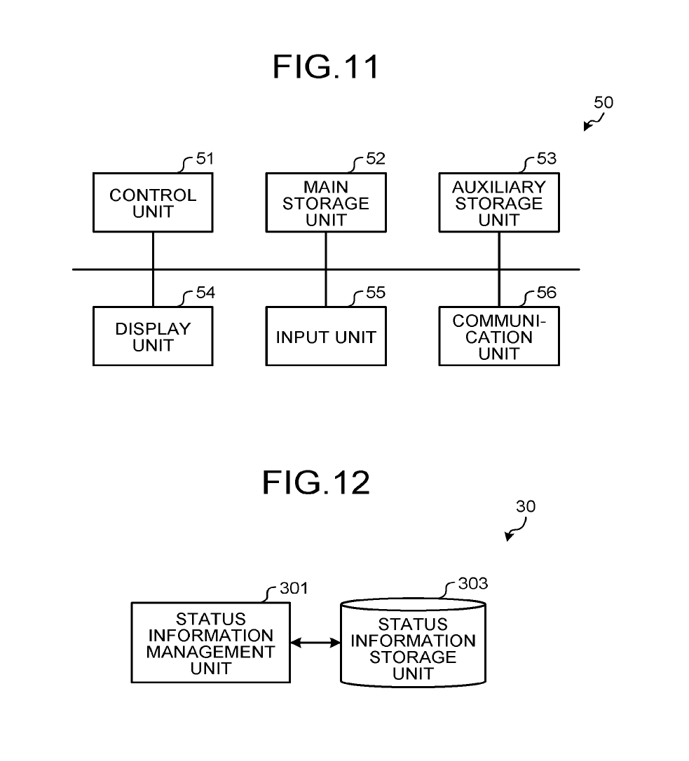

FIG. 11 is a block diagram of an example of a hardware configuration of the status management unit 50 according to the first embodiment. As illustrated in FIG. 11, the status management unit 50, which is provided with a control unit 51 such as a CPU and a GPU, a main storage unit 52 such as a ROM and a RAM, an auxiliary storage unit 53 such as an HDD and an SSD, a display unit 54 such as a display, an input unit 55 such as a mouse, a keyset, and a touch-sensitive panel, and a communication unit 56 such as a communication interface, has a hardware configuration using a normal computer. The auxiliary storage unit 53, the display unit 54, the input unit 55, and the communication unit 56 may be provided each as a built-in unit or an external unit.

FIG. 12 is a block diagram of an example of a functional configuration of the status management unit 50 according to the first embodiment. The status management unit 50, which manages status information concerning non-normal statuses having arisen in the devices 40-1 to 40-n (ticket), is provided with a status information management unit 501 and a status information storage unit 503 as illustrated in FIG. 12. The status information management unit 501 can be realized by the control unit 51 and the main storage unit 52 and the status information storage unit 503 can be realized by the auxiliary storage unit 53, for example.

The status information storage unit 503 stores status information concerning non-normal statuses having arisen in the devices 40-1 to 40-n. For non-normal statuses, which are statuses different from a normal status in which the device works normally, a status where an error occurs can be listed, for example. The status where an error occurs corresponds to a status where the device cannot work normally without resolving the error.

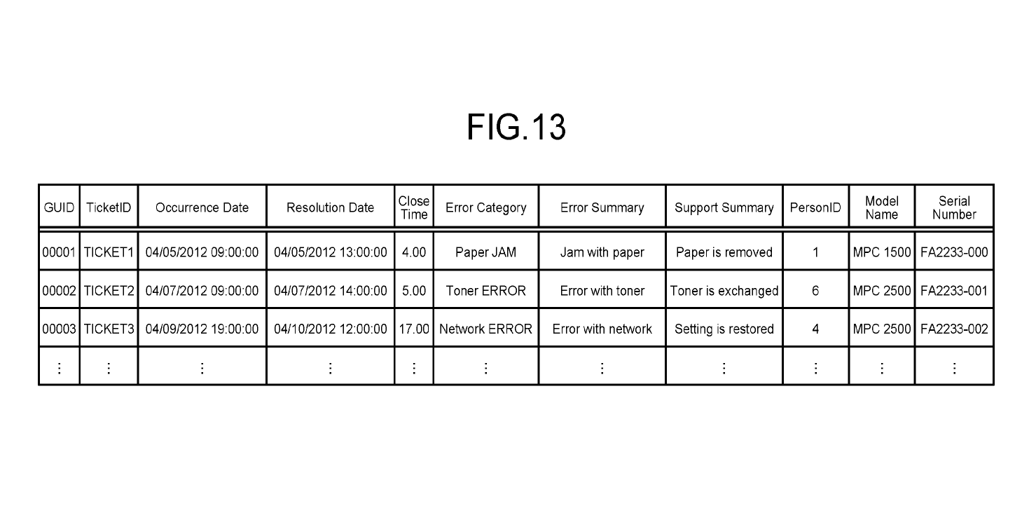

FIG. 13 illustrates an example of status information according to the first embodiment. In the example illustrated in FIG. 13, the status information includes information in which GUID, TicketID, Occurrence Date, Resolution Date, Close Time, Error Category, Error Summary, Support Summary, PersonID, Model Name, and SerialNumber are associated.

The “GUID” is an identifier that identifies a record of status information (column of status information). The “TicketID” is an identifier that identifies an error having occurred. The “Occurrence Date” is a date when an error occurred. The “Resolution Date” is a date when an error is resolved. The “Close Time” (an example of temporal information), which is a time required for causing a non-normal status to return to the normal status, i.e., a time required from the occurrence of the error to the resolution thereof, corresponds to a period calculated by a subtraction “Resolution Date”−“Occurrence Date”. A device in which an error occurred is considered to be in operation stop during the Close Time. The “Error Category” (an example of status classification identifying information), which identifies a classification of an error having occurred, is a category of an error, for example. The “Error Summary” is a summary of error content. The “Support Summary” is a summary of content of a support made to an error. The “PersonID” (an example of person identifying information) is an identifier that identifies a person who performed a support for causing the non-normal status to return to the normal status, i.e., a service person who resolved the error. The “Model Name” is a model name of a device in which an error occurred. The “SerialNumber” is an identifier that identifies a device in which an error occurred.

The status information management unit 501 manages an input and an output of the status information stored in the status information storage unit 503. The status information management unit 501 updates the status information stored in the status information storage unit 503 when new status information is input to issue a ticket slip or when update information of existing status information is input to close the ticket via the input unit 55 by a management person of the status management unit 50, for example.

When a SerialNumber is input via the communication unit 56 from the information processing apparatus 60, the status information management unit 501 obtains a record of status information including the SerialNumber from the status information stored in the status information storage unit 503 and responds to the information processing apparatus 60 with the record. It is necessary that the record of the status information obtained by the status information management unit 501 at least includes the “Close Time” and the “Error Category” which are associated with the “SerialNumber”.

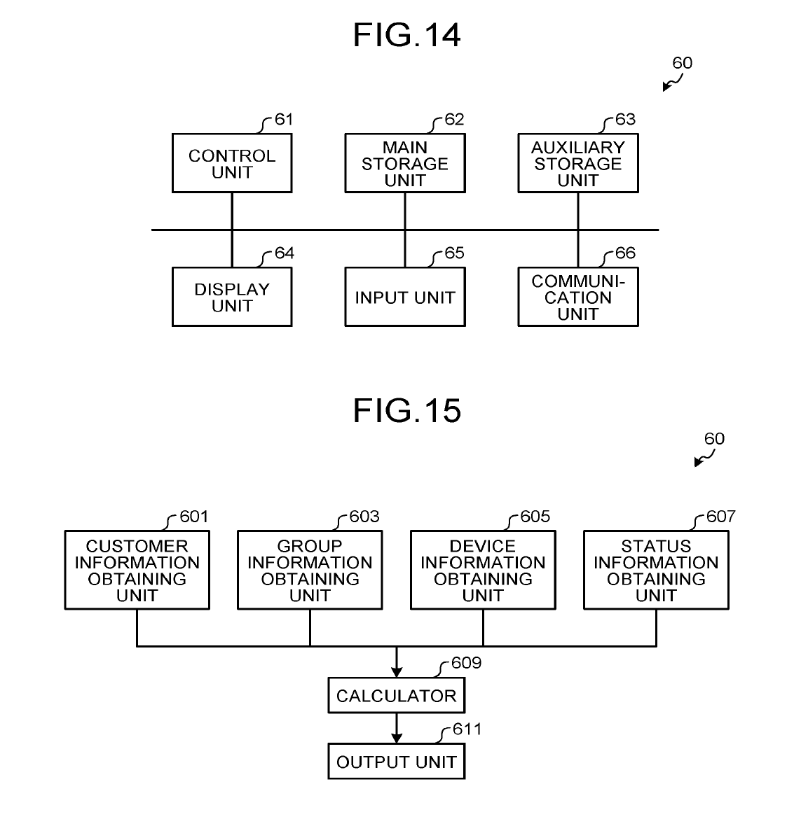

FIG. 14 is a block diagram of an example of a hardware configuration of the information processing apparatus 60 according to the first embodiment. As illustrated in FIG. 14, the information processing apparatus 60, which is provided with a control unit 61 such as a CPU and a GPU, a main storage unit 62 such as a ROM and a RAM, an auxiliary storage unit 63 such as an HDD and an SSD, a display unit 64 such as a display, an input unit 65 such as a mouse, a keyset, and a touch-sensitive panel, and a communication unit 66 such as a communication interface, has a hardware configuration using a normal computer. The auxiliary storage unit 63, the display unit 64, the input unit 65, and the communication unit 66 may be provided each as a built-in unit or an external unit.

FIG. 15 is a block diagram of an example of a functional configuration of the information processing apparatus 60 according to the first embodiment. The information processing apparatus 60 obtains customer information from the customer management unit 10, group information from the group management unit 20, device information from the device management unit 30, and status information from the status management unit 50 and outputs recommendation information. Details of the recommendation information will be explained later. As illustrated in FIG. 15, the information processing apparatus 60 is provided with a customer information obtaining unit 601, a group information obtaining unit 603 (an example of a region information obtaining unit), a device information obtaining unit 605, a status information obtaining unit 607, a calculator 609, and an output unit 611.

The customer information obtaining unit 601, the group information obtaining unit 603, the device information obtaining unit 605, the status information obtaining unit 607, and the output unit 611 can be realized by the control unit 61, the main storage unit 62, and the communication unit 66 and the calculator 609 can be realized by the control unit 61 and the main storage unit 62, for example.

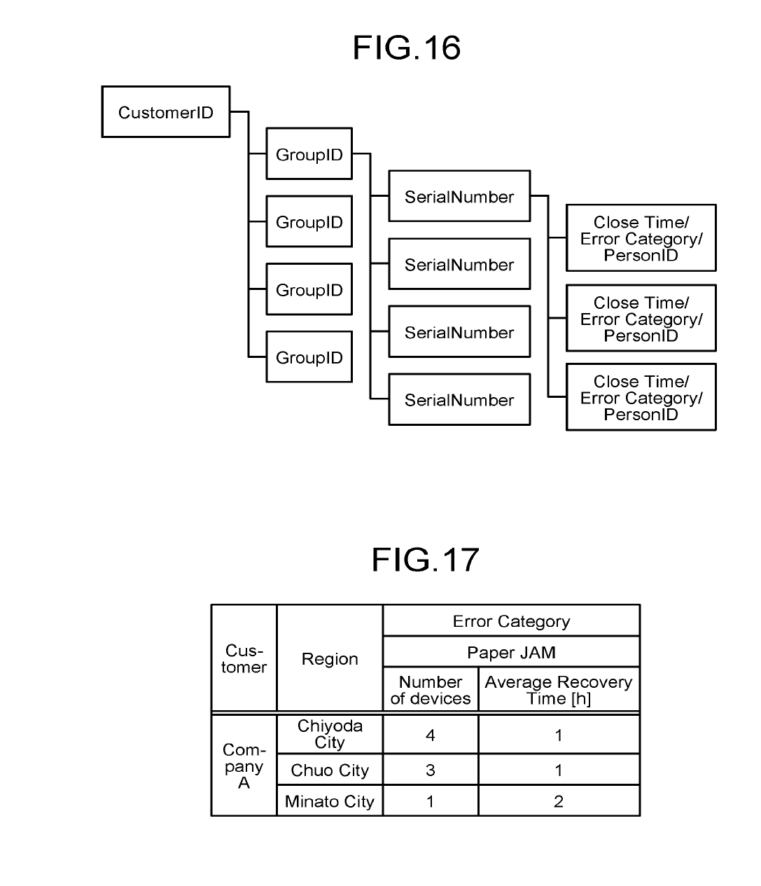

FIG. 16 illustrates an example of a hierarchy structure of the customer information, the group information, the device information, and the status information according to the first embodiment and exemplifies CustomerID as the customer information, GroupID as the group information, SerialNumber as the device information, Close Time/Error Category/PersonID as the status information. Information used for generating recommendation information has a hierarchy structure in which the Close Time/Error Category/PersonID belongs to the SerialNumber which belongs to the GroupID which belongs to the CustomerID as illustrated in FIG. 16.

The customer information obtaining unit 601 obtains customer information of a predetermined customer. When “company A” which is the Name of a predetermined customer is input from the user terminal 80 via the communication unit 66 for example, the customer information obtaining unit 601 transmits the Name to the customer management unit 10 via the communication unit 66 and obtains a record of customer information including the Name from the customer management unit 10 (the record whose GUID is “00001” in the example illustrated in FIG. 4). The customer information obtaining unit 601 thus obtains customer information whose CustomerID indicates “CUSTOMER001” (company A), i.e., customer information of the company A which is the predetermined customer.

The group information obtaining unit 603 obtains group information of the predetermined customer by using the customer information of the predetermined customer obtained by the customer information obtaining unit 601. The group information obtaining unit 603 transmits the CustomerID “CUSTOMER001” included in the record of the customer information obtained by the customer information obtaining unit 601 to the group management unit 20 via the communication unit 66, for example, and obtains records of group information including the CustomerID (the records of GUIDs “00001” to “00007” in the example of the group information illustrated in FIG. 7) from the group management unit 20. The group information obtaining unit 603 thus obtains group information of the company A which is the predetermined customer.

The device information obtaining unit 605 obtains device information of the predetermined customer by using the group information of the predetermined customer obtained by the group information obtaining unit 603. The device information obtaining unit 605 transmits at least any GroupID included in the records of the group information obtained by the group information obtaining unit 603 to the device management unit 30 via the communication unit 66 and obtains a record of device information including the GroupID from the device management unit 30.

Here, the device information obtaining unit 605, for example, transmits GroupIDs of the “Chiyoda city”, “Chuo city”, and “Minato city”, i.e., GroupIDs “GROUP3”, “GROUP4”, and “GROUP5” to the device management unit 30 via the communication unit 66 and obtains records of device information including any of those GroupIDs (the records of the GUIDs “00001” to “00004” in the example of the device information illustrated in FIG. 10) from the device management unit 30. The device information obtaining unit 605 thus obtains device information of devices installed in the Chiyoda city, the Chuo city, and the Minato city (more specifically, devices installed in a branch office and a regional office, locating at the Chiyoda city, the Chuo city, and the Minato city) of the company A which is the predetermined customer.

In the case where the device information obtaining unit 605 transmits a part of GroupIDs included in the records of the group information obtained by the group information obtaining unit 603 to the device management unit 30 as explained above, it is only necessary that the user terminal 80 specifies, via the communication unit 66, a GroupID as a target of the transmission with respect to the device information obtaining unit 605. Here, the device information obtaining unit 605 may transmit all the GroupIDs included in the records of the group information obtained by the group information obtaining unit 603 to the device management unit 30.

The status information obtaining unit 607 uses the device information, obtained by the device information obtaining unit 605, of the predetermined customer to obtain status information of a device indicated by the device information. The status information obtaining unit 607 transmits SerialNumbers “FA2233-000”, “BC2233-111”, “FA2233-001”, and “FA2233-002” (see FIG. 10) included in the records of the device obtained by the device information obtaining unit 605 to the status management unit 50 via the communication unit 66, for example. The status information obtaining unit 607 then obtains records of status information including any of those SerialNumbers (the records of GUIDs “00001” to “00003” in the example of the status information illustrated in FIG. 13) from the status management unit 50.

On this occasion, to associate the GroupID used for the obtainment with status information to be obtained, the status information obtaining unit 607 transmits SerialNumbers associated with the GroupID to the status management unit 50 for each GroupID. In the cases of the examples illustrated in FIGS. 10 and 13, the status information obtaining unit 607 transmits SerialNumbers “FA2233-000” and “BC2233-111” to the status management unit 50 as for the “GROUP3” and obtains a record whose GUID is “00001”. The status information obtaining unit 607 transmits SerialNumber “FA2233-001” to the status management unit 50 as for the “GROUP4” and obtains a record whose GUID is “00003”. The status information obtaining unit 607 transmits the SerialNumber “FA2233-002” to the status management unit 50 as for the “GROUP5” and obtains a record whose GUID is “00004”.

The status information obtaining unit 607 thus obtains status information of devices installed in each of the Chiyoda city, the Chuo city, and the Minato city of the company A. In other words, for each group indicated by the Group ID used for the obtainment, the status information obtaining unit 607 obtains status information of at least one device, arranged in the group, among the devices 40-1 to 40-n.

For each group indicated by the Group ID used for the obtainment of device information, the calculator 609 calculates operation information of at least one device arranged in the group based on the status information obtained by the status information obtaining unit 607. While an example of a case where the operation information is an average recovery time of a predetermined Error Category of at least one device arranged in a group is taken as an example and explained in the first embodiment, the present invention is not limited thereto. In the first embodiment, the calculator 609 further calculates person recovery information that indicates an average recovery time of a predetermined Error Category for each service person indicated by the PersonID included in the status information obtained by the status information obtaining unit 607. Here, it is only necessary that the user terminal 80 specifies the predetermined Error Category with respect to the calculator 609 via the communication unit 66.

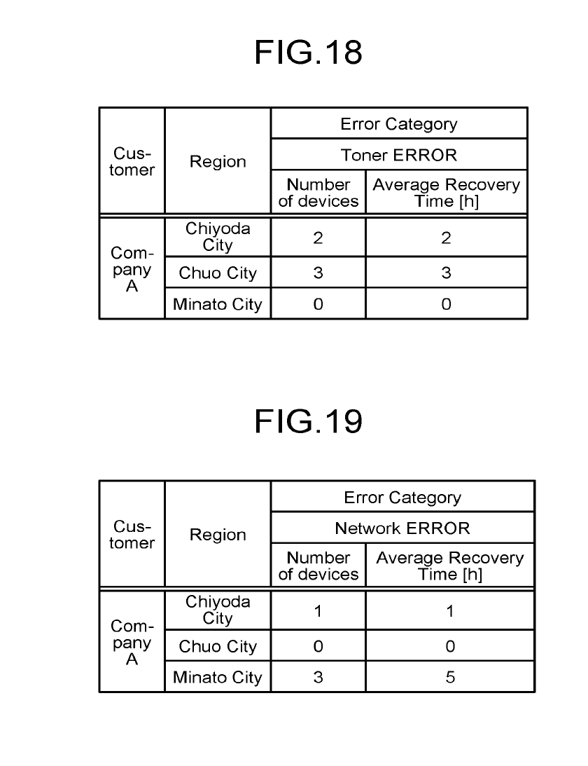

FIGS. 17 to 19 illustrate examples of operation information for each group according to the first embodiment and specifically illustrate, for each group indicated by the GroupID used for the obtainment of the device information, an average recovery time of a predetermined Error Category of at least one device arranged in the group. The predetermined Error Category is “Paper JAM” in the example illustrated in FIG. 17, “Toner ERROR” in the example illustrated in FIG. 18, and “Network ERROR” in the example illustrated in FIG. 19.

Here, an average recovery time of a given group is calculated by dividing, by the number of records of status information for a predetermined Error Category, a value of a sum total of Close Time of the status information record for the predetermined Error Category among at least one status information record, obtained by the status information obtaining unit 607, of the given group. For example, in the case of Chiyoda city in FIG. 17, since a sum total of the Close Time of the status information records for the Error Category “Paper JAM” is four hours among at least one status information record of the Chiyoda city obtained by the status information obtaining unit 607 and the number of status information records for the Error Category “Paper JAM” is four, the average recovery time is one hour.

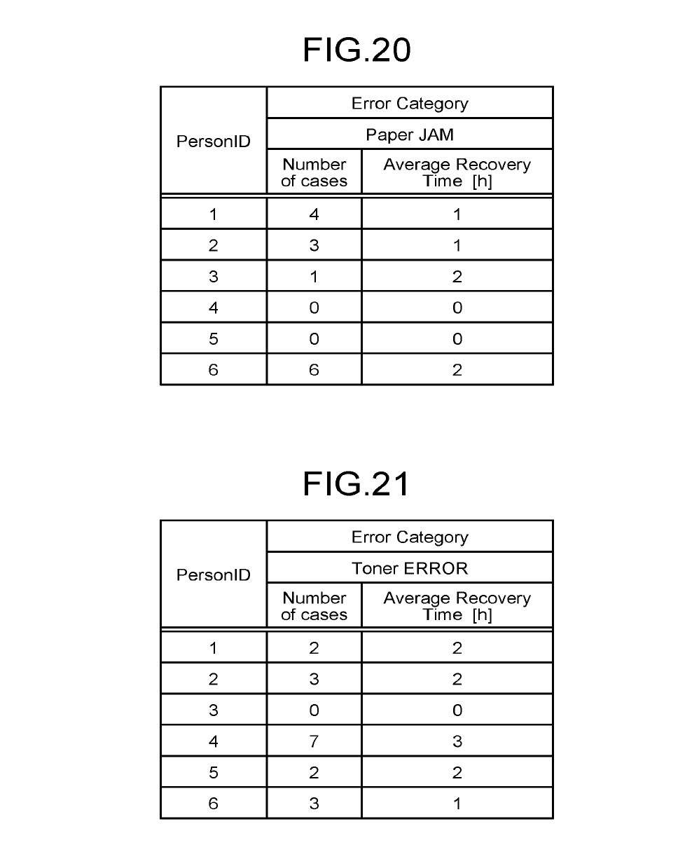

FIGS. 20 to 22 illustrate examples of person recovery information according to the first embodiment and specifically illustrate an average recovery time of a predetermined Error Category for each service person indicated by the PersonID included in status information obtained by the status information obtaining unit 607. The predetermined Error Category is “Paper JAM” in the example illustrated in FIG. 17, “Toner ERROR” in the example illustrated in FIG. 18, and “Network ERROR” in the example illustrated in FIG. 19.

Here, an average recovery time of a given service person is calculated by dividing, by the number of records of status information indicating the corresponding Error Category and the given service person, a value of a sum total of Close Time of the status information record whose Error Category is a predetermined Error Category and whose PersonID indicates the given service person among the status information records obtained by the status information obtaining unit 607. For example, in the case of a person whose PersonID illustrated in FIG. 20 is “1”, since a sum total of the Close Time of the record of the status information whose Error Category is “Paper JAM” and whose PersonID is “1” among the status information records obtained by the status information obtaining unit 607 is four hours and the number of status information records whose Error Category is “Paper JAM” and whose PersonID is “1” is four, the average recovery time is one hour.

The output unit 611 outputs recommendation information that indicates a recommendation based on at least one piece of operation information calculated by the calculator 609. In the first embodiment, the output unit 611 outputs recommendation information presenting a recommendation based on at least one piece of operation information and person recovery information calculated by the calculator 609.

Specifically, the output unit 611 uses the at least one piece of operation information calculated by the calculator 609 to specify a group whose average recovery time of a predetermined Error Category is the longest, and uses the person recovery information calculated by the calculator 609 to specify a service person with a PersonID whose average recovery time of the predetermined Error Category is the shortest. The output unit 611 then outputs, as recommendation information, information indicating a recommendation of associating the group whose average recovery time is the longest with the service person whose average recovery time is the shortest to the user terminal 80 via the communication unit 66.

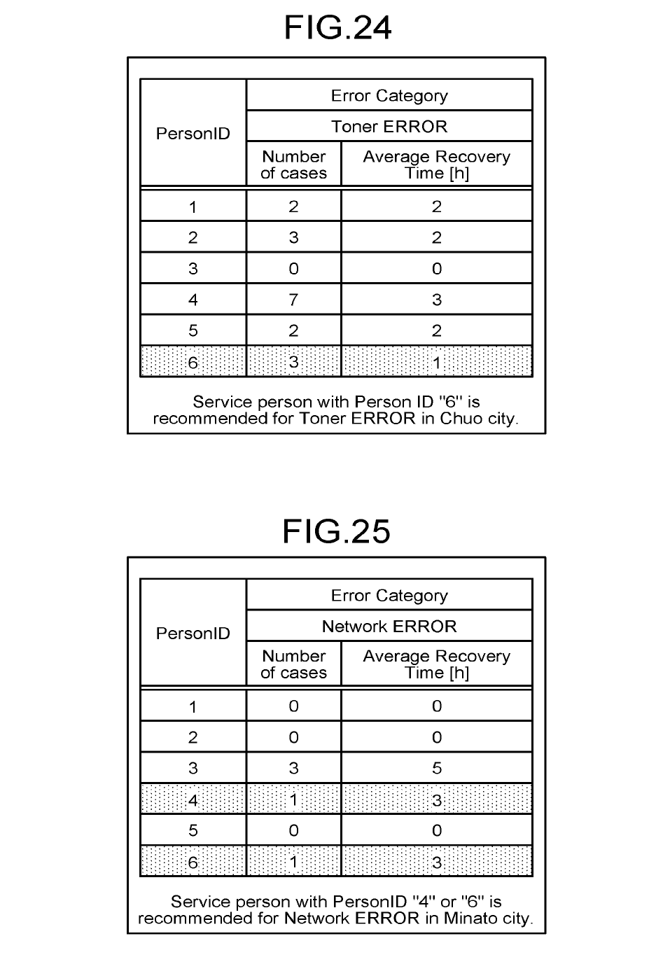

FIGS. 23 to 25 illustrate examples of recommendation information according to the first embodiment. The predetermined Error Category is “Paper JAM” in the example illustrated in FIG. 23, “Toner ERROR” in the example illustrated in FIG. 24, and “Network ERROR” in the example illustrated in FIG. 25.

The group whose average recovery time is the longest is Minato city in the example illustrated in FIG. 17 and the service person whose average recovery time is the shortest has PersonID “1” in the example illustrated in FIG. 20. Specifically, though the respective average recovery times of the service person whose PersonID is “1” and the service person whose PersonID is “2” are one hour, the service person whose PersonID is “1” is of advantage because the number of cases is larger. While the respective average recovery times of the service person whose PersonID is “4” and the service person whose PersonID is “5” are zero hour, the service persons who deal with no case are exempted. The output unit 611 therefore outputs recommendation information of associating the Minato city whose average recovery time is the longest with the service person with PersonID “1” whose average recovery time is the shortest in the case where the predetermined Error Category is “Paper JAM” as illustrated in FIG. 23.

The group whose average recovery time is the longest is Chuo city in the example illustrated in FIG. 18 and the service person whose average recovery time is the shortest is a service person whose PersonID is “6” in the example illustrated in FIG. 21. Therefore, the output unit 611 outputs recommendation information of associating the Chuo city whose average recovery time is the longest with the service person with PersonID “6” whose average recovery time is the shortest in the case where the predetermined Error Category is “Toner ERROR” as illustrated in FIG. 24.

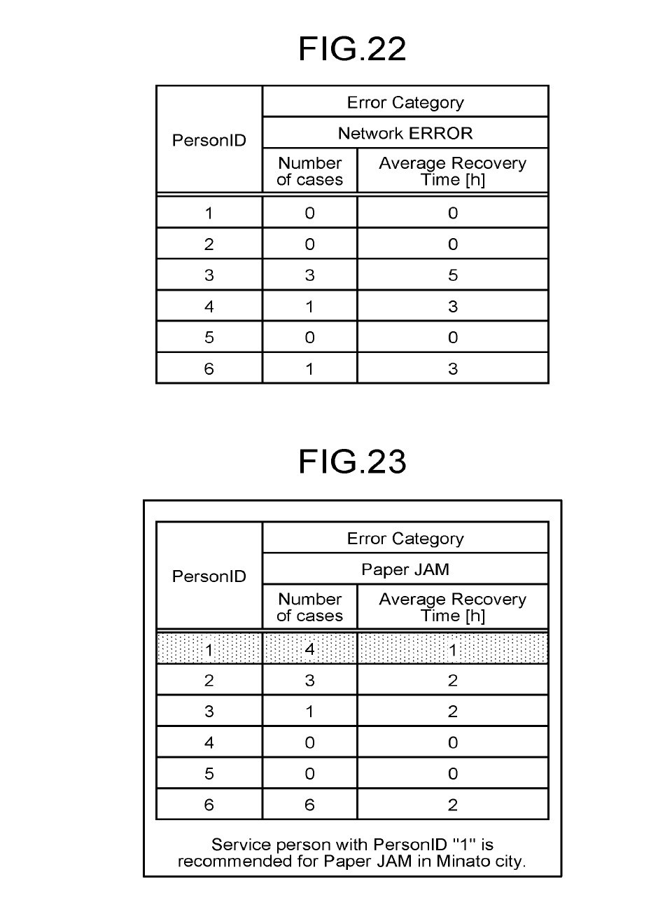

The group whose average recovery time is the longest is Minato city in the example illustrated in FIG. 19 and the service person whose average recovery time is the shortest has PersonID “4” or “6” in the example illustrated in FIG. 22. Therefore, the output unit 611 outputs recommendation information of associating the Minato city whose average recovery time is the longest with the service person with PersonID “4” or “6” whose average recovery time is the shortest in the case where the predetermined Error Category is “Network ERROR” as illustrated in FIG. 25.

The user terminal 80 inputs, to the information processing apparatus 60 on a browser, a Name of a predetermined customer, a GroupID as a transmission target among GroupIDs included in the records of the group information, and a predetermined Error Category to request for an output of recommendation information. The user terminal 80 then obtains the recommendation information output from the information processing apparatus 60 and displays the obtained recommendation information on the browser.

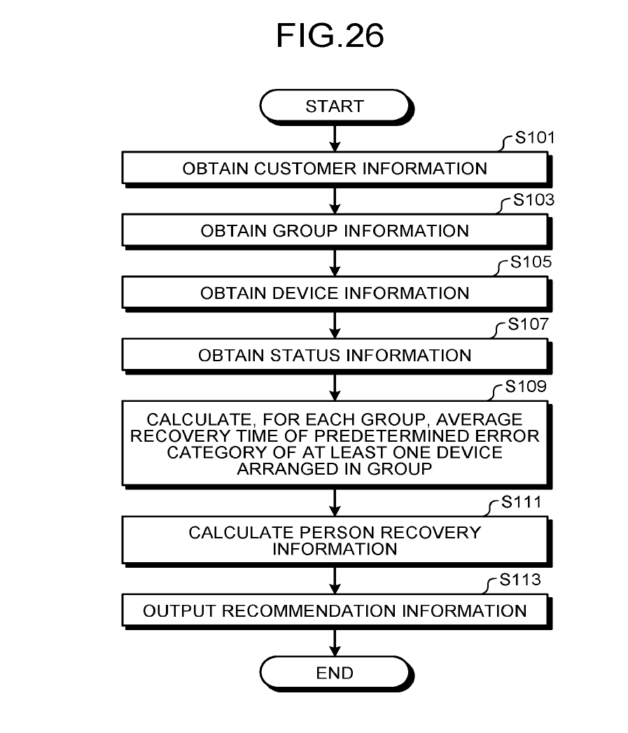

FIG. 26 is a flowchart of an example of a processing to be executed by the information processing apparatus 60 according to the first embodiment.

First, when the Name of a predetermined customer is input from the user terminal 80 via the network 2, the customer information obtaining unit 601 of the information processing apparatus 60 transmits the Name to the customer management unit 10 via the network 2, obtains a record of customer information including the Name from the customer management unit 10, and obtains customer information of the predetermined customer (step S101).

The group information obtaining unit 603 of the information processing apparatus 60 transmits a CustomerID included in the record of the customer information obtained by the customer information obtaining unit 601 to the group management unit 20 via the network 2, obtains a record of group information including the CustomerID from the group management unit 20, and obtains group information of the predetermined customer (step S103).

The device information obtaining unit 605 of the information processing apparatus 60 then transmits at least any one of GroupIDs included in the record of the group information obtained by the group information obtaining unit 603 to the device management unit 30 via the network 2, obtains a record of device information including the Group ID from the device management unit 30, and obtains device information of the predetermined customer (step S105).

The status information obtaining unit 607 of the information processing apparatus 60 then transmits, for each GroupID included in the record of the device information obtained by the device information obtaining unit 605, a SerialNumber which is associated with the GroupID to the status management unit 50 via the network 2 and obtains a record of status information including the SerialNumber from the status management unit 50, thereby obtaining status information of at least one device arranged in the group for each group indicated by the GroupID used for the obtainment of device information (step S107).

The calculator 609 of the information processing apparatus 60 then calculates, for each group indicated by the GroupID used for the obtainment of device information, an average recovery time of a predetermined Error Category of at least one device arranged in the group based on the status information obtained by the status information obtaining unit 307 (step S109).

Next, the calculator 609 of the information processing apparatus 60 further calculates person recovery information that indicates an average recovery time of a predetermined Error Category for each service person indicated by the PersonID included in the status information obtained by the status information obtaining unit 607 (step S111).

Then, the output unit 611 of the information processing apparatus 60 uses at least one piece of operation information calculated by the calculator 609 to specify a group whose average recovery information of the predetermined category is the longest, and uses the person recovery information calculated by the calculator 609 to specify a service person with a PersonID whose average recovery time of the predetermined Error Category is the shortest. The output unit 611 outputs, as recommendation information to the user terminal 80 via the communication unit 66, information recommending an association of the group whose average recovery time is the longest with the service person whose average recovery time is the shortest (step S113).

As explained so far, it is possible in the first embodiment to recommend a service person whose average recovery time of a predetermined Error Category is the shortest to a group whose average recovery time of the predetermined Error Category is the longest by utilizing device-related information which is accumulated daily in managing the operational statuses of a device for MPS service, and thereby lead to an improvement in operation availability of the device by group unit.

### Second Embodiment

In a second embodiment, an example of a case where operation information is average operation availability for each model of at least one device arranged in a group will be taken as an example and explained. A difference from the first embodiment will be explained mainly below, a constituent having the same function as the first embodiment will be assigned with the same name and reference symbol, and the explanation thereof will be omitted.

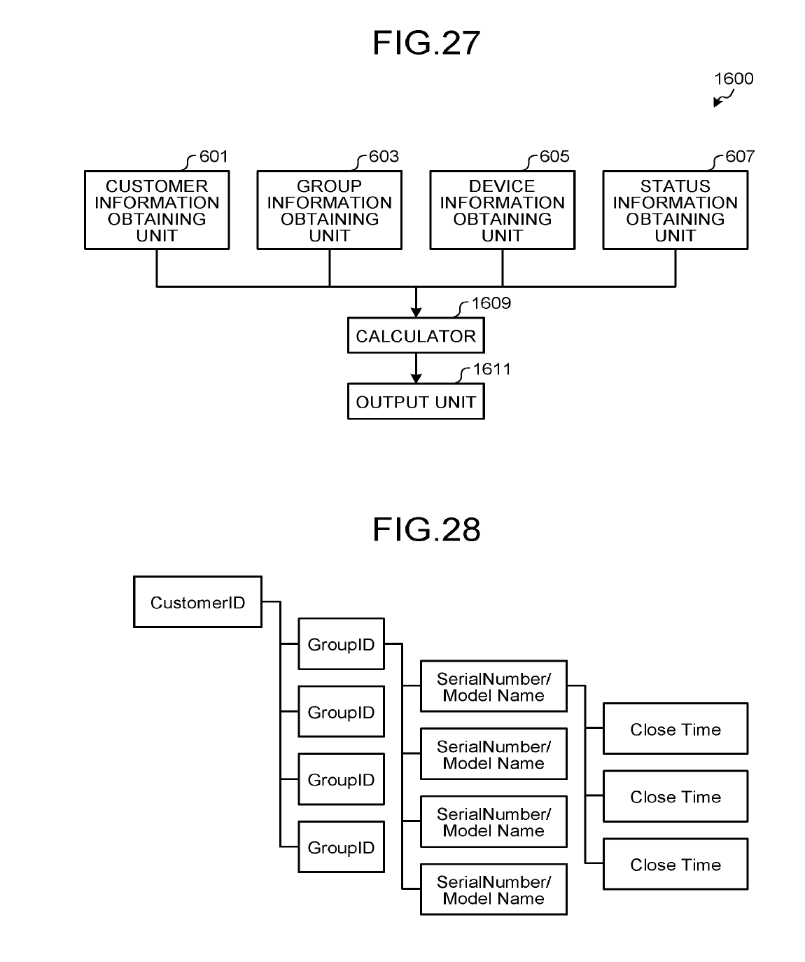

FIG. 27 is a block diagram of an example of a configuration of an information processing apparatus 1600 according to a second embodiment. As illustrated in FIG. 27, the information processing apparatus 1600 according to the second embodiment has difference in a calculator 1609 and an output unit 1611 from the first embodiment.

FIG. 28 illustrates an example of a hierarchy structure of customer information, group information, device information, and status information according to the second embodiment and exemplifies CustomerID as customer information, GroupID as group information, SerialNumber/Model Name as device information, and Close Time as status information. Information used for generating recommendation information has a hierarchy structure in which the Close Time belongs to the SerialNumber/Model Name which belongs to the GroupID which belongs to the CustomerID as illustrated in FIG. 28.

While the example in which the device information obtaining unit 605 obtains device information of devices installed in the Chiyoda city, Chuo city, and Minato city of the company A is explained in the first embodiment, the device information obtaining unit 605 is configured to obtain device information of devices installed in the company A in Japan in the second embodiment. Specifically, the device information obtaining unit 605 transmits GroupID “GROUP1” to the device management unit 30 via the communication unit 66 and obtains records of device information including the GroupID (the records of GUIDs “00001” to “00004” in the example of the device information illustrated in FIG. 10) from the device management unit 30 in the second embodiment.

While the case where operation information is average operation availability for each Model Name of at least one device as explained is taken as an example and explained in the second embodiment, the present invention is not limited thereto.

The calculator 1609 calculates average operation availability for each Model Name of at least one device in the group indicated by the GroupID used for the obtainment of device information. For example, the calculator 1609 calculates average operation availability for each Model Name in the group through a division, by a sum total operation time of the Model Name, of time obtained by subtracting a sum total of Close Time included in status information of the Model Name in the status information obtained by the status information obtaining unit 607 from the sum total operation time of the model for each Model Name of the at least one device arranged in the group.

The calculation of the average operation availability will be explained specifically. Here, a device whose Model Name is “MPC 2500” will be taken as an example and explained. In this example, it is assumed that there are two devices, with SerialNumbers “FA2233-001” and “FA2233-002”, whose Model Name is “MPC 2500” installed in the company A in Japan and the status information obtained by the status information obtaining unit 607 is what is illustrated in FIG. 13. Besides, it is assumed that the average operation availability is a value per month and an estimated operation time of one device per month is 160 hours (8 hours×20 days).

In this case, since the sum total operation time of the device whose Model Name is “MPC 2500” installed in the company A in Japan is 320 hours (2 devices×160 hours), the sum total time of the Close Time is 22 hours (5 hours+17 hours) (see FIG. 13), the average operation availability becomes 93.1% (100%×(320 hours−22 hours)/320 hours).

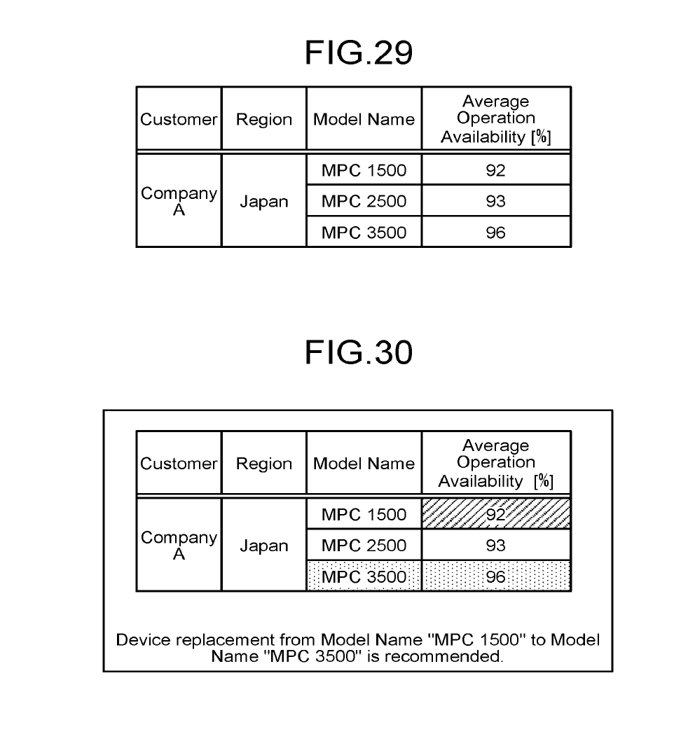

FIG. 29 illustrates an example of operation information according to the second embodiment and specifically illustrates average operation availability for each Model Name of the at least one device installed in the company A in Japan. In the example illustrated in FIG. 29, the average operation availability of a device whose Model Name is “MPC 1500” is the lowest and the average operation availability of a device whose Model Name is “MPC 3500” is the highest.

The output unit 1611 outputs recommendation information of recommending a model replacement of the at least one device based on the average operation availability calculated by the calculator 1609. Specifically, the output unit 1611 outputs recommendation information of recommending a replacement from the model whose average operation availability is the lowest to the model whose average operation availability is the highest in the at least one device.

FIG. 30 illustrates an example of recommendation information according to the second embodiment. Since the average operation availability of the device whose Model Name is “MPC 1500” is the lowest and the average operation availability of the device whose Model Name is “MPC 3500” is the highest as explained with reference to FIG. 29, a replacement of the device whose Model Name is “MPC 1500” with the device whose Model Name is “MPC 3500” is recommended in the example illustrated in FIG. 30.

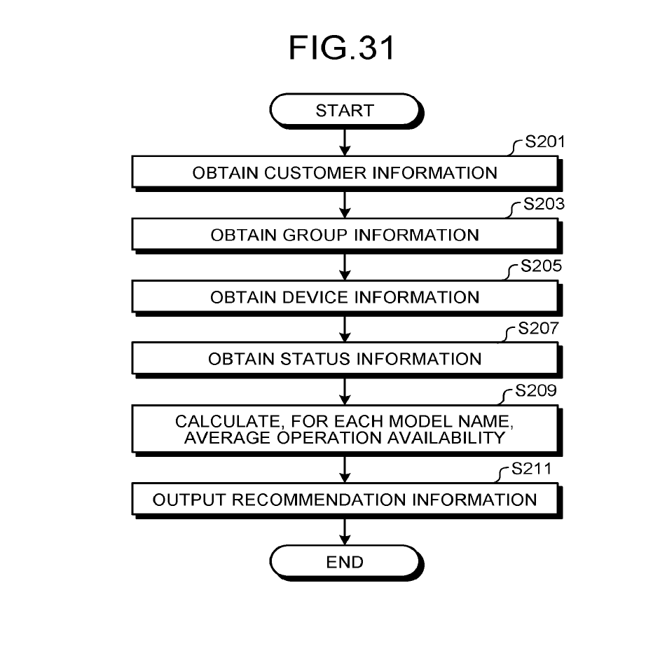

FIG. 31 is a flowchart of an example of a processing to be executed by the information processing apparatus 1600 according to the second embodiment.

A processing from step S201 to step S207 is the same as the processing from step S101 to step S107 in the flowchart illustrated in FIG. 26.

The calculator 1609 of the information processing apparatus 1600 calculates average operation availability for each Model Name of the at least one device in the group indicated by the GroupID used for the obtainment of device information (step S209).

The output unit 1611 of the information processing apparatus 1600 then outputs recommendation information of recommending a replacement of the model whose average operation availability is the lowest with the model whose average operation availability is the highest in the at least one device in the group indicated by the GroupID used for the obtainment of device information to the user terminal 80 via the communication unit 66 (step S211).

As explained so far, it is possible in the second embodiment to recommend a replacement of a model whose average operation availability is the lowest with a model whose average operation availability is the highest in at least one device in a group and to lead to the improvement in operation availability of device by group unit by utilizing, for MPS, device-related information which is accumulated daily in managing the operational statuses of device. Especially when the average operation availability differs, even in devices of the same model, from each other for each group (for each country, for example), it is of benefit that a recommendation of a replacement with a device whose average operation availability is high can be made. The difference in the average operation availability even in the devices of the same model for each group can be attributed to the difference in environment, for example.

Modification

In the above-explained embodiments, the device information managed by the device management unit and the status information managed by the status management unit may be built for the information processing system, may be information managed in a report system and the like that creates a service report of operational statuses of a device, or may be information with which the information managed in the report system is synchronized. Besides, the information processing system according to the embodiments may be realized as a function of a report system that creates a service report of operational statuses of a device.

While the example of building the information processing system by the customer management unit, the group management unit, the device management unit, the device, the status management unit, the information processing apparatus, and the user terminal is explained in the embodiments, the present invention is not limited thereto and it is possible to make a configuration such that a function of any of the units is substituted by another unit. For example, the information processing apparatus may be configured to be further provided with the functions of the customer management unit, the group management unit, the device management unit, and the status management unit to build the information processing system.

While the example in which the customer management unit stores customer information, the group management unit stores group information, the device management unit stores device information, and the status management unit stores status information is explained in the embodiments, at least any one of those pieces of information may be stored in an external unit (on a cloud, for example).

Programs

Programs to be executed in the customer management unit, the group management unit, the device management unit, the device, the status management unit, the information processing apparatus, and the user terminal (hereinbelow referred to as “units” according to the embodiments”) may be provided by being recorded in a file of an installable format or of an executable format in a computer-readable recording medium such as a CD-ROM, a CD-R, a memory card, a DVD (Digital Versatile Disk), and a flexible disk (FD).

The programs to be executed in the units according to the embodiments may be stored on a computer connected to a network such as the Internet and provided by being downloaded via the network. The programs to be executed in the units according to the embodiments may be provided or distributed via a network such as the Internet. The programs to be executed in the units according to the embodiments may be provided by being preloaded in a ROM and the like.

The programs to be executed in the units according to the embodiments have a module configuration that enables realizing the units explained above on a computer. As an actual hardware, the functional units are configured to be realized on a computer when the CPU reads out from the ROM onto the RAM and execute the programs.

According to the embodiments, there is an advantage of being capable of utilizing accumulated device-related information for service.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a processor that performs program stored in memory, the processor performing steps of:
obtaining, for each of at least one region, status information concerning a non-normal status having occurred in at least one device arranged in the region, from among a plurality of devices to be managed;
calculating operation information of the at least one device based on the obtained status information for each of the at least one region; and
outputting recommendation information indicating a recommendation based on the operation information of the at least one device.

2. The information processing apparatus according to claim 1, wherein
the status information includes status classification identifying information indicating a classification of the non-normal status, temporal information indicating a time required for returning to a normal status from the non-normal status, and person identifying information indicating a person who performs a support for returning to the normal status from the non-normal status,
the operation information is an average recovery time of a predetermined classification of the non-normal status of the at least one device,
the processor further performs a step of calculating person recovery information indicating an average recovery time of the predetermined classification of the non-normal status for each person indicated by person information included in the status information obtained in the at least one region; and
the recommendation is based on the operation information of the at least one device and the person recovery information.

3. The information processing apparatus according to claim 2, wherein the processor further performs steps of:
specifying, by using the operation information of the at least one device, a region whose average recovery time of the predetermined classification of the non-normal status is longest;
specifying, by using the person recovery information, a person whose average recovery time of the predetermined classification of the non-normal status is shortest; and
outputting, as the recommendation information, information indicating a recommendation of associating the region whose average recovery time is the longest with the person whose average recovery time is the shortest.

4. The information processing apparatus according to claim 1, wherein
the status information includes model identifying information indicating a model of a device in which the non-normal status has occurred and temporal information indicating a time required for returning to a normal status from the non-normal status,
the operation information is an average operation availability for each model of the at least one device, and
the output unit outputs, as the recommendation information, information of recommending a model replacement of the at least one device based on the average operation availability.

5. The information processing apparatus according to claim 4, wherein the processor further performs a step of outputting, as the recommendation information, information of recommending a replacement of a model whose average operation availability is lowest with a model whose average operation availability is highest in the at least one device in the region.

6. The information processing apparatus according to claim 4, wherein the processor further performs a step of calculating an average operation availability for each model of the at least one device in the region through a division, by a sum total operation time of the model, of time obtained by subtracting a sum total of time indicated by the temporal information included in the status information of the model indicated by the model identifying information in the obtained status information from the sum total operation time of the model for each model of the at least one device.

7. The information processing apparatus according to claim 1, wherein the processor further performs steps of:
obtaining customer information including at least customer identifying information that identifies a customer and indicates a predetermined customer;
obtaining, by using the obtained customer information, at least one piece of region information that includes at least the customer identifying information that indicates the predetermined customer and region identifying information that identifies a region by which a customer is divided; and
obtaining, by using at least any of the at least one piece of the obtained region information, at least one piece of device information that includes at least device identifying information that identifies a device and the region identifying information that indicates the region of the predetermined customer, wherein
the status information includes the device identifying information and
the status information obtaining unit obtains, as the status information, information including any of the at least one piece of the device identifying information included in the at least one piece of the obtained device information.

8. An information processing method performed by a processor that performs program stored in memory, the method comprising steps of:
storing status information concerning a non-normal status having occurred in a plurality of devices as management target;
obtaining, for each of at least one region, status information of at least one device arranged in the region, from among a plurality of devices to be managed;
calculating operation information of the at least one device based on the obtained status information for each of the at least one region; and
outputting recommendation information indicating a recommendation based on the operation information of the at least one device.

9. A non-transitory computer-readable recording medium with an executable program stored thereon and executed by a computer, wherein the program instructs the computer to perform:
obtaining, for each of at least one region, status information concerning a non-normal status having occurred in at least one device arranged in the region, from among a plurality of devices to be managed;
calculating operation information of the at least one device based on the obtained status information for each of the at least one region; and
outputting recommendation information indicating a recommendation based on the operation information of the at least one device.
